(19) United States
(12) Patent Application Publication
(10) Pub. No.: US 2026/0319630 A1
(43) Pub. Date: Oct. 15, 2026

(54) USER INTERFACE FIELD CONFIGURABILITY ENHANCEMENTS

(71) Applicant: Fidelity Information Services, LLC, Jacksonville, FL (US)

(72) Inventor: Surojit Das, Pune (IN)

(21) Appl. No.: 19/404,495

(22) Filed: Dec. 1, 2025

(30) Foreign Application Priority Data
Apr. 14, 2025 (IN) 202511036062

(51) Int. Cl. G06F 3/0481; G06F 3/0484

(52) U.S. Cl. CPC G06F 3/0481; G06F 3/0484

(57) ABSTRACT

The present disclosure provides a system that causes user interface elements corresponding to data entry fields to be rendered on a user device, detects a user interface configurability trigger, causes a toggle switch to be rendered, receives user input indicating selection of the toggle switch, identifies unfilled and required data entry fields, determines a first subset of user interface elements corresponding to the unfilled and required data entry fields, and causes the first subset to be rendered while removing a second subset of user interface elements indicated as filled or optional from the user interface.

### CROSS REFERENCE TO RELATED APPLICATIONS

This application claims priority to Indian Patent Application No. 202511036062, filed Apr. 14, 2025, titled “USER INTERFACE FIELD CONFIGURABILITY ENHANCEMENTS,” the entire contents of which are incorporated herein by reference.

### TECHNICAL FIELD

User interfaces have become increasingly complex as applications and systems offer more features and functionality. The innovations described herein relate to solutions to complex user interfaces using user interface field configurability enhancements.

### BACKGROUND

User interfaces, particularly graphical user interfaces, provide the ability for users to interact with functionality of applications and remote systems. Some user interfaces deal with a large number of fields and/or a large amount of information, making interaction by a user difficult. As user interfaces continue to evolve and accommodate more sophisticated functionality, there is a growing need for flexible and intuitive ways to manage the display and interaction with numerous data entry fields. Improvements in this area could potentially enhance user experience, increase efficiency in form completion, reduce errors in data input across various applications and systems, and save on valuable computing resources.

### SUMMARY OF THE INVENTION

The described innovations include a system with processors and non-transitory computer-readable media storing instructions that, when executed by the processors, cause the processors to perform operations comprising causing user interface elements to be rendered on a user device via a user interface, the user interface elements corresponding to data entry fields, detecting a user interface configurability trigger associated with the user interface elements, causing, based at least in part on detecting the user interface configurability trigger, a toggle switch to be rendered via the user interface, receiving first user input data indicating selection of the toggle switch, based at least in part on receiving the first user input data, identifying which of the data entry fields are indicated as being unfilled and required, determining a first subset of the user interface elements that correspond to the data entry fields indicated as being unfilled and required, and causing the first subset of the user interface elements to be rendered on the user device via the user interface such that a second subset of the user interface elements indicated as being at least one of filled or optional are removed from the user interface.

Also described is a method comprising rendering user interface elements on a user device via a user interface, wherein the user interface elements correspond to data entry fields, rendering a toggle switch via the user interface, receiving first user input data indicating selection of the toggle switch, based at least in part on receiving the first user input data, identifying which of the data entry fields are indicated as being unfilled and required, determining a first subset of the user interface elements that correspond to the data entry fields indicated as being unfilled and required, and rendering the first subset of the user interface elements via the user interface such that a second subset of the user interface elements indicated as being at least one of filled or optional are removed from the user interface.

Also described is a system with processors and non-transitory computer-readable media storing instructions that, when executed by the processors, cause the processors to perform operations comprising rendering user interface elements on a user device via a user interface, wherein the user interface elements correspond to data entry fields, rendering a toggle switch via the user interface, receiving first user input data indicating selection of the toggle switch, based at least in part on receiving the first user input data, identifying which of the data entry fields are indicated as being unfilled and required, determining a first subset of the user interface elements that correspond to the data entry fields indicated as being unfilled and required, and rendering the first subset of the user interface elements via the user interface such that a second subset of the user interface elements indicated as being at least one of filled or optional are removed from the user interface.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment for user interface field configurability enhancements, according to aspects of the present disclosure.

FIG. 2 illustrates example user interfaces for managing data entry fields, according to aspects of the present disclosure.

FIG. 3 illustrates example user interfaces showing different states of a form display, according to an embodiment.

FIG. 4 illustrates example user interfaces for a single-question form display, according to aspects of the present disclosure.

FIG. 5 illustrates a block diagram of components for determining whether to render a toggle switch for user interface field configurability, according to aspects of the present disclosure.

FIG. 6 illustrates a flowchart of a process for managing toggle switch activation, according to aspects of the present disclosure.

FIG. 7 illustrates a flowchart of a process for implementing user interface field configurability enhancements, according to an embodiment.

FIG. 8 illustrates a flowchart of another process for implementing user interface field configurability enhancements, according to aspects of the present disclosure.

FIG. 9 illustrates a flowchart of a method for generating and utilizing machine learning models, according to an embodiment.

### DETAILED DESCRIPTION

Systems and methods are provided for user interface field configurability enhancements. Specifically, the present disclosure relates to user interface field configurability enhancements for improving form completion and data entry processes. These enhancements may provide users with greater control over the display of and interaction with form fields, particularly in scenarios involving complex or lengthy forms. In implementations, the user interface field configurability enhancements may include a toggle switch feature. This toggle switch may allow users to switch between viewing all form fields and viewing incomplete and required fields. By providing this functionality, users may more easily focus on relevant information that needs to be entered, potentially reducing cognitive load and improving efficiency in form completion tasks.

The user interface field configurability enhancements may also improve accessibility in form-filling experiences. In implementations, users may be able to customize how form fields are presented based on their individual needs and/or preferences. This customization capability may make forms more accessible to a range of users, including those with different cognitive or visual abilities. By offering these configurability options, the system may enhance the overall user experience when interacting with forms. In some implementations, this may lead to improved form completion rates, reduced errors in data entry, and increased user satisfaction with digital form-filling processes.

In addition to the above, the user interface field configurability enhancements may reduce computational load on user devices by decreasing simultaneous rendering of a large number of data entry fields. The system may implement efficient data structures and rendering algorithms that allow for dynamic loading and unloading of form fields based on user interactions. For example, when a user toggles to view incomplete and required fields, the system may unload or otherwise remove unnecessary field data from at least some components of memory and render the relevant subset of data entry fields. This approach can significantly reduce memory usage and processing requirements, particularly for forms with hundreds or thousands of data entry fields. As a result, devices with limited computational resources may be able to handle complex forms more smoothly, with reduced lag and improved responsiveness.

The innovations described herein may also reduce data saving requirements by dynamically adjusting the number of displayed data entry fields. When a user activates the toggle switch to show incomplete and required fields, the system may implement a selective data persistence strategy. This approach involves maintaining active data connections for the visible fields, while temporarily suspending data synchronization for hidden fields. The technical process may involve using a combination of client-side caching and server-side session management to efficiently track field states. By reducing the number of active data connections and synchronization operations, the system can minimize network traffic, decrease server load, and optimize storage utilization. This can lead to faster form interactions and reduced data transfer costs.

The user interface field configurability enhancements may also contribute to reduced error rates in data entry and processing. The system may implement real-time field validation coupled with the toggle switch functionality to highlight potential errors more effectively. For example, when a user switches to view incomplete and required fields, the system may automatically run validation checks on the visible fields, providing immediate feedback on discrepancies or missing information. This targeted approach to error checking can help users identify and correct mistakes more quickly, reducing the likelihood of submitting forms with errors. Additionally, the system may employ machine learning algorithms to analyze patterns in user input across multiple form submissions, allowing it to proactively suggest corrections or auto-fill certain fields based on historical data. These technical features can contribute to improved data accuracy and reliability in form processing systems.

Furthermore, the innovations described herein enable effective data filtering on devices with small screens through adaptive layout techniques and prioritized content rendering. When the toggle switch is activated to show a subset of data entry fields indicated as incomplete and required, the system may employ a responsive design framework that dynamically adjusts the form layout based on the available screen real estate. This technical approach may also include implementing a virtual scrolling mechanism that loads the visible portion of the form corresponding to the incomplete and required data entry fields, reducing memory usage and improving performance on resource-constrained devices. By intelligently managing the display of form fields and prioritizing essential information, the system can provide a more focused and efficient user experience on small screens, potentially increasing form completion rates on mobile devices.

To achieve the above technical benefits (among others), the system may render user interface elements corresponding to data entry fields on a user device and may detect a user interface configurability trigger. When this occurs, the system may render a toggle switch, and upon receiving user input selecting the toggle switch, the system may identify unfilled and required data entry fields. The system may then determine a subset of user interface elements corresponding to these fields, and may render this subset while removing other elements from the user interface. In addition to the above, the system may also include rendering options for required and optional fields associated with the toggle switch.

Furthermore, the system may determine when to render the toggle switch based on various factors. These factors may include the number of data entry fields, the data field format (e.g., sequential vs. decision-tree), user profile preferences, device type, screen size, and/or artificial intelligence model results. The system may also consider the category of data entry fields, attributes of entered data values, and anticipated completion time, among other factors, when deciding whether to render the toggle switch. The system may also automatically remove user interface elements when data entry fields are filled and the toggle switch is activated such that no data entry fields are presented based on all such required fields being filled. The system may also determine user profiles indicating preferences for activating the toggle switch and may automatically render subsets of user interface elements based on these preferences. Furthermore, the system may automatically render subsets of elements when the number of data entry fields exceeds a threshold.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

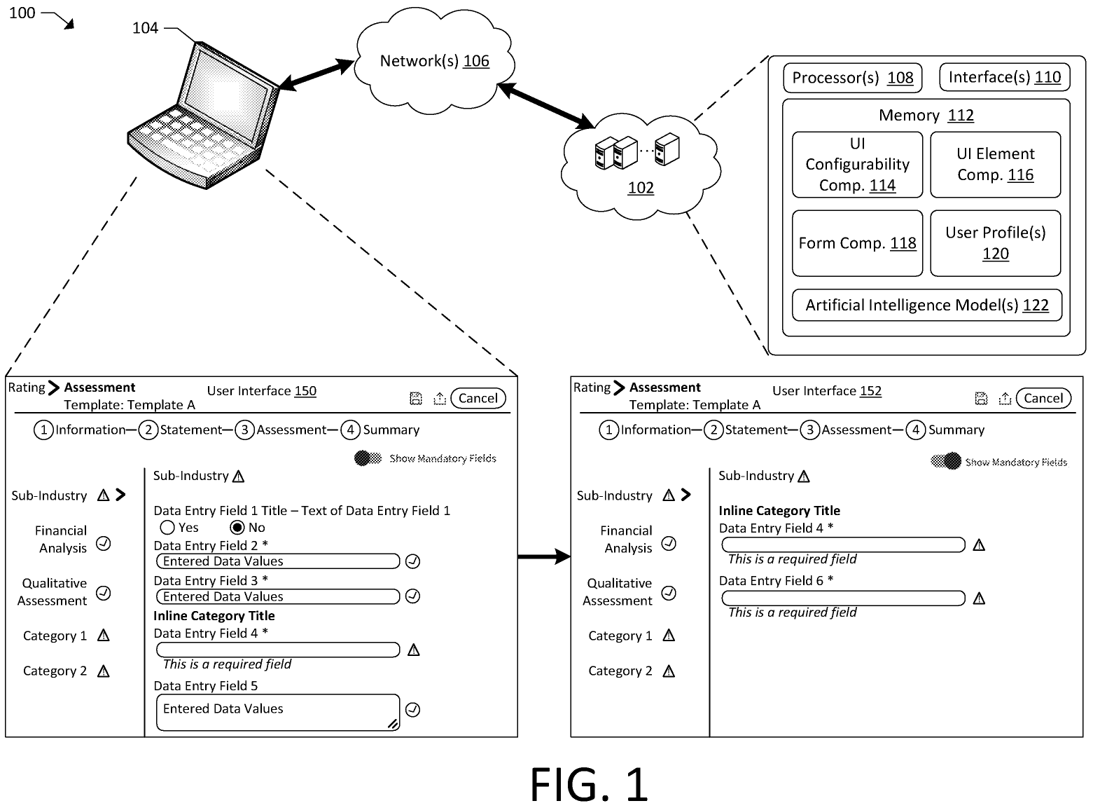

FIG. 1 illustrates a system environment 100 for implementing user interface field configurability enhancements. The system environment 100 may include a remote system 102, a client device 104, and a communication network 106. In examples, the remote system 102 may comprise one or more processors and non-transitory computer-readable media storing instructions. The instructions, when executed by the one or more processors, may cause the remote system 102 to perform various operations related to user interface field configurability, as described in detail below.

The client device 104 may be configured to display user interface elements corresponding to data entry fields. In examples, the remote system 102 may cause the user interface elements to be rendered on the client device 104 via a user interface (such as user interface 150 and/or user interface 152). The user interface elements may represent various types of data entry fields, such as text input boxes, dropdown menus, buttons, and/or checkboxes.

The communication network 106 may facilitate data exchange between the remote system 102 and the client device 104. In examples, the communication network 106 may include wired or wireless connections, or a combination of both. The communication network 106 may enable the transmission of instructions (otherwise described herein as commands) from the remote system 102 to the client device 104 for rendering the user interface elements, as well as the transmission of user input data from the client device 104 back to the remote system 102.

The system environment 100 may be configured to implement the process for managing user interface elements and toggle switch functionality as described in previous sections. By utilizing the components of the system environment 100, the user interface field configurability enhancements may be applied to improve form completion and data entry processes. The remote system 102 may include several components that work together to implement the user interface configurability enhancements. In examples, the remote system 102 may include one or more processors 108, an interface component 110, and memory 112. The processors 108 may be configured to execute instructions stored in the memory 112 to perform various operations related to user interface configurability. In examples, the processors 108 may process user input data received from the client device 104 and generate appropriate responses or actions based on the input. The interface component 110 may facilitate communication between the remote system 102 and other components of the system environment 100, such as the client device 104. In examples, the interface component 110 may manage the transmission of data and instructions over the communication network 106.

The memory 112 may store various software components and data structures used in implementing the user interface configurability enhancements. In examples, the memory 112 may include a UI configurability component 114, a UI element component 116, a form component 118, a user profile 120, and/or an artificial intelligence model 122.

The UI configurability component 114 may be responsible for managing the overall configuration of the user interface, including the implementation of the toggle switch functionality. In examples, the UI configurability component 114 may determine when and how to render the toggle switch based on various factors, as described below. The UI element component 116 may handle the rendering and management of individual user interface elements, such as data entry fields and form controls. In examples, the UI element component 116 may work in conjunction with the UI configurability component 114 to adjust the display of user interface elements based on the toggle switch state.

The form component 118 may manage the structure and logic of forms presented to users. In examples, the form component 118 may track the completion status of data entry fields and identify which fields are required or optional. The user profile 120 may store user-specific information and preferences related to user interface configurability. In examples, the user profile 120 may include settings for default toggle switch behavior or preferred form display options.

The artificial intelligence model 122 may be trained to determine the likelihood that a user will select the toggle switch. In examples, the artificial intelligence model 122 may analyze user behavior patterns, form complexity, and other factors to generate predictions associated with toggle switch activation. The remote system 102 may utilize artificial intelligence results from the artificial intelligence model 122, which may indicate the likelihood of a user selecting the toggle switch. In examples, the UI configurability component 114 may use these artificial intelligence results to determine whether to render the toggle switch on the client device 104. Based on the artificial intelligence results indicating that a user may be likely to select the toggle switch, the remote system 102 may render the toggle switch on the client device 104. In examples, this proactive rendering of the toggle switch may enhance the user experience by providing the configurability option before the user explicitly requests it.

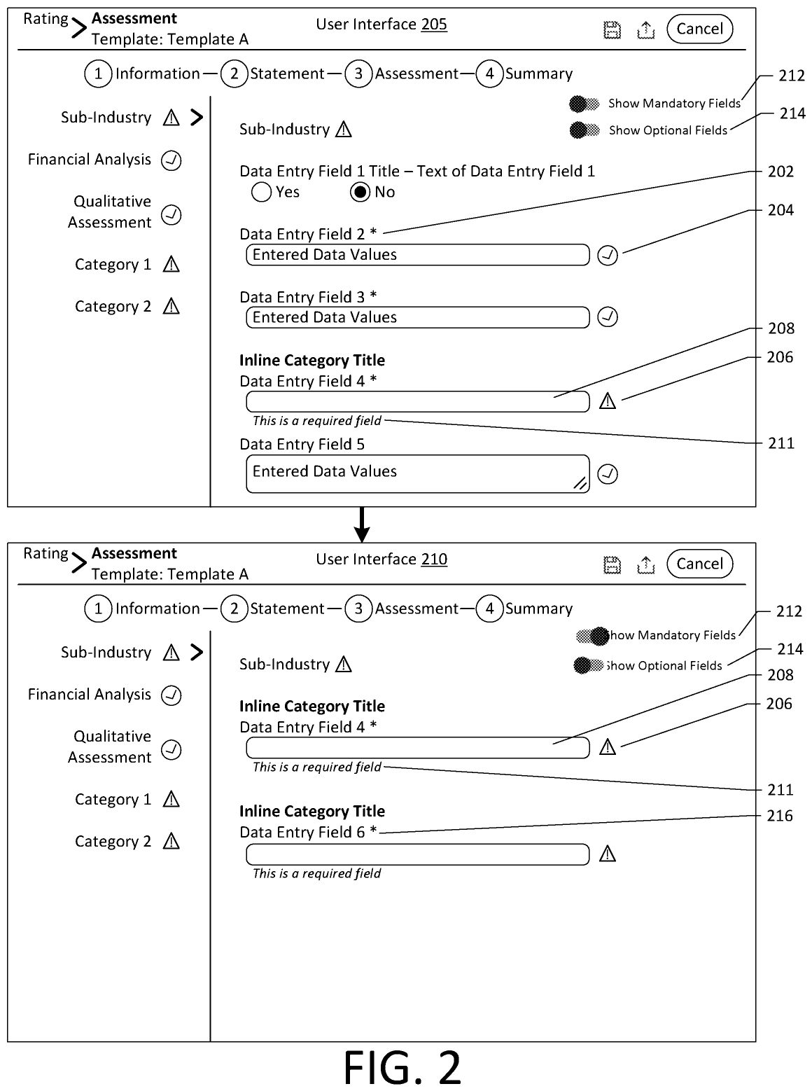

To illustrate the above, and utilizing FIG. 1 as an example, user interface 150 may serve as a primary interface for user interaction with the client device 104, presenting a comprehensive set of data entry fields and form elements. This user interface 150 may be dynamically rendered based on instructions received from the remote system 102, utilizing various components such as the UI configurability component 114 and the UI element component 116. The user interface 150 may include a variety of input methods, such as text fields, dropdown menus, buttons, and checkboxes, allowing users to enter data efficiently. The user interface 150 may feature a toggle switch (described in detail in FIGS. 2-4) that enables users to filter the display to show a subset of user interface elements associated with data entry fields that are unfilled and required, potentially improving form completion rates. The user interface 150 may also incorporate real-time field validation, providing immediate feedback on data entry errors.

At the outset, the UI configurability component 114 may determine whether a user interface configurability trigger associated with the user interface elements has been detected. For example, the UI configurability component 114 may send a command to the client device 104 to render the toggle switch described herein when a form contains numerous data entry fields. This process may involve determining the total number of fields present in the form and comparing this count to a predetermined threshold value. When the number of data entry fields satisfies this threshold, the UI configurability component 114 may detect a user interface configurability trigger. This trigger may then prompt the system to implement changes to the interface, such as rendering the toggle switch, to enhance usability and potentially simplify the form completion process for users. By dynamically adapting the interface based on the form's complexity, the system may provide a more manageable and efficient data entry experience, particularly for forms with a large number of fields.

In another example, the UI configurability component 114 may send a command to the client device 104 to render the toggle switch described herein when the system detects that the data entry fields follow a sequential format rather than a decision-tree format. A sequential format typically presents fields in a linear order on a single scrollable screen, where users progress through the form data entry field by data entry field. In contrast, a decision-tree format may dynamically change the presented fields based on previous user inputs. The form component 118 may analyze the structure and relationships between fields to determine the format type. For instance, the form component 118 may look for branching logic and/or conditional field displays that are characteristic of decision-tree formats. If such features are absent and fields are presented in a straightforward sequence, the form component 118 may classify the format as sequential. This determination may be detected as a user interface configurability trigger because sequential formats benefit from different navigation and display options compared to decision-tree formats. For example, in a sequential format, a toggle switch to show unfilled and required fields may be particularly useful, as it allows users to quickly identify remaining tasks without navigating through complex branching structures.

In another example, the UI configurability component 114 may send a command to the client device 104 to render the toggle switch described herein when a user profile 120 indicates a preference for viewing data entry fields that are both unfilled and required. Based on this preference, the UI configurability component 114 may send a command to the client device 104 to render the toggle switch. This adaptive approach allows the system to tailor the user interface to individual user needs. By providing quick access to unfilled and required fields through the toggle switch, the system may enhance form completion efficiency. The rendering of the toggle switch based on user profile preferences may occur proactively, potentially improving the user experience by anticipating user needs before explicit requests are made.

In another example, the UI configurability component 114 may send a command to the client device 104 to render the toggle switch described herein based on the type of device being used to access the user interface. In examples, the UI configurability component 114 may determine the device type of the client device 104 that is being utilized to render the user interface elements. The UI configurability component 114 may also evaluate whether this identified device type corresponds to any predefined device types that are associated with rendering of the toggle switch. If the UI configurability component 114 determines that the device type is indeed a predefined device type suitable for toggle switch functionality, it may proceed to render the toggle switch on the client device 104. This approach may allow the system to tailor the user interface and toggle switch presentation to different device capabilities, potentially optimizing the form completion experience across various device types such as desktop computers, tablets, or smartphones.

In another example, the UI configurability component 114 may send a command to the client device 104 to render the toggle switch described herein based at least in part on form categorization. The UI configurability component 114 may analyze the data entry fields to determine their associated category. This categorization process may involve examining the field types, data formats, and/or semantic context of the form elements. Once a category is identified, the UI configurability component 114 may check if it is associated with toggle switch functionality. For example, certain categories of forms, such as financial assessments or multi-step applications, may benefit from the ability to focus on unfilled and required fields. If such an association exists, the UI configurability component 114 may send a command to the client device 104 to render the toggle switch. This decision to display the toggle switch may be influenced by the categorical association, allowing the user interface to dynamically adapt and present an appropriate input method for the given data type.

In another example, the UI configurability component 114 may send a command to the client device 104 to render the toggle switch described herein based on the data values associated with filled data entry fields. In examples, the UI configurability component 114 may examine the attributes of the entered data (also described herein as data values), such as the length, format, or content type of the values. Based on this analysis, the UI configurability component 114 may assess whether the attributes indicate a benefit associated with the toggle switch functionality. For example, if the entered data suggests a complex form with diverse field types, the UI configurability component 114 may determine that the toggle switch would be beneficial for user navigation. Once the UI configurability component 114 makes this determination, it may send a command to the client device 104 to render the toggle switch. This process allows the system to dynamically adapt the user interface 150 based on the actual data entered by users, potentially enhancing the form completion experience by providing relevant navigation tools when they are most likely to be useful.

In another example, the UI configurability component 114 may send a command to the client device 104 to render the toggle switch described herein based on an anticipated amount of time for users to complete a form. This analysis may consider factors such as the number of fields, their complexity, and historical data on user completion times, for example. If the anticipated completion time exceeds a predefined threshold amount of time, the UI configurability component 114 may trigger the rendering of the toggle switch on the client device 104. By providing this toggle switch functionality when forms are expected to take longer to complete, the system may offer users a more efficient way to navigate and focus on essential fields, potentially reducing the overall time required for form completion. This adaptive approach to rendering the toggle switch based on anticipated completion time may enhance user experience, particularly for complex or time-consuming forms.

In another example, the UI configurability component 114 may send a command to the client device 104 to render the toggle switch described herein based on a screen size of the client device 104. In examples, the UI configurability component 114 may determine the display dimensions of the client device 104, which may involve querying the device for its screen resolution and/or utilizing information provided by the client device's 104 operating system. The UI configurability component 114 may then compare the detected screen size to a predetermined threshold value associated with effective toggle switch functionality. If the UI configurability component 114 determines that the screen size meets or exceeds this threshold, the UI configurability component 114 may proceed to render the toggle switch on the client device 104. This approach may allow the system to adapt the user interface based on the available display real estate, potentially ensuring that the toggle switch is only presented when it can be comfortably viewed and interacted with by the user.

When the toggle switch is selected, as described herein, the form component 118 may determine which of the data entry fields are indicated as being unfilled and required, and the UI element component 116 may determine which user interface elements represent a subset of the user interface elements associated with the data entry fields that are indicated as being unfilled and required. A command may be sent to the client device 104 configured to cause the user interface 152 to display the subset of user interface elements associated with the unfilled and required data entry fields while removing other user interface elements that are at least one of filled or not required. As such, the user interface 152 may provide a streamlined view of form elements, focusing on unfilled and required data entry fields. This focused view may include visual indicators such as asterisks or highlighting to denote required fields. The user interface 152 may also incorporate real-time validation feedback, alerting users to any errors or missing information as they progress through the form. The user interface 152 may also adapt its layout based on the device type and screen size, ensuring optimal visibility and usability across various platforms. The interface may include navigation elements allowing users to easily switch between the comprehensive view (user interface 150) and this more focused presentation of form fields.

It should be noted that the exchange of data and/or information as described herein may be performed only in situations where a user has provided consent for the exchange of such information. For example, a user may be provided with the opportunity to opt in and/or opt out of data exchanges between devices and/or with the systems and/or for performance of the functionalities described herein. Additionally, when one of the devices is associated with a first user account and another of the devices is associated with a second user account, user consent may be obtained before performing some, any, or all of the operations and/or processes described herein.

As used herein, a processor, such as processor(s) 108, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 108 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 108 may possess its own local memory, which also may store program components, program data, and/or one or more operating systems.

The memory 112 may include volatile and nonvolatile memory, removable and non-removable media implemented in any method or technology for storage of information, such as computer-readable instructions, data structures, program component, or other data. Such memory 112 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 112 may be implemented as computer-readable storage media (“CRSM”), which may be any available physical media accessible by the processor(s) 108 to execute instructions stored on the memory 112. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information, and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 112 discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Washington, USA; the Windows operating system from Microsoft Corporation of Redmond, Washington, USA; LynxOS as promulgated by Lynx Software Technologies, Inc. of San Jose, California; Operating System Embedded (Enea OSE) as promulgated by ENEA AB of Sweden; and so forth.

The network interface(s) 110 may enable messages between the components and/or devices shown in environment 100 and/or with one or more other remote systems, as well as other networked devices. Such network interface(s) 110 may include one or more network interface controllers (NICs) or other types of transceiver devices to send and receive messages over the network.

For instance, each of the network interface(s) 110 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 110 may include a wide area network (WAN) component to enable message over a wide area network.

In some instances, the remote system 102 or portions thereof may be local to an environment associated the user device 104. In some instances, some or all of the functionality of the remote system 102 may be performed by the user device 104. Also, while various components of the remote system 102 have been labeled and named in this disclosure and each component has been described as being configured to cause the processor(s) to perform certain operations, it should be understood that the described operations may be performed by some or all of the components and/or other components not specifically illustrated.

In light of the above, the intelligent rendering of a toggle switch in user interfaces as described herein improve accessibility in form-filling experiences, reduce computational load on user devices by decreasing simultaneous rendering of a large number of data entry fields, reduce data saving requirements by dynamically adjusting the number of displayed data entry fields, contribute to reduced error rates in data entry and processing, and enable effective data filtering on devices with small screens through adaptive layout techniques and prioritized content rendering utilizing the UI configurability component 114, UI element component 116, form component 118, user profile(s) 120, and artificial intelligence model(s) 122, as described more fully above.

FIG. 2 illustrates a user interface 205 that may be displayed on a client device, such as the client device 104 from FIG. 1. The user interface 205 may include various elements for data entry and form completion. In examples, the user interface 205 may include a data entry title 202 at the top of or otherwise proximate to a data entry field. The data entry title 202 may provide context and/or instructions for the information to be entered in the associated data entry field.

A completion indicator 204 may be displayed in association with data entry fields to show the status of entered data. For unfilled data fields, an incomplete-field indicator 206 may be presented. The incomplete-field indicator 206 may visually distinguish fields that require user input from those that have been completed. The user interface 205 may also include an unfilled data field 208 where users may enter information. In examples, a required-field message 211 may be displayed to indicate when a particular field must be completed.

To illustrate the above using FIG. 2, a number of data entry titles 202 may be presented. Those data entry titles 202 may be Data Entry Field 1, Data Entry Field 2, Data Entry Field 3, Data Entry Field 4, and Data Entry Field 5. Data Entry Field 1 may include selectable options such as virtual buttons that may be "pressed" to indicate an answer, such as "yes" or "no." Data Entry Field 2, Data Entry Field 3, and Data Entry Field 5 may all include the completion indicator 204 indicating that each of these data entry fields have been completed. Additionally, all of these fields may show entered data values, which may correspond to the user input received in those respective fields. Also as shown in FIG. 2, Data Entry Field 4 may have an incomplete-field indicator 206 associated with it, and the corresponding data entry field may not include entered data values. The required-field message 211 may also be displayed in association with Data Entry Field 4 to further indicate that data values are required to be entered in this field.

In addition to the above, a toggle switch 212 that may be rendered on the user interface 205 to enhance user interaction with data entry fields. This toggle switch 212 may allow users to selectively view different subsets of data entry fields based on their completion status and/or other criteria. Users may interact with the toggle switch 212 by tapping, clicking, or sliding it, depending on the specific implementation and device type. For instance, users may activate the toggle switch 212 to display only those fields that are unfilled and required, thereby simplifying the interface and focusing the user's attention on essential inputs (this is shown in user interface 210). The toggle switch 212 may be integrated into various forms and applications, providing a dynamic tool for improving data entry efficiency and accuracy. Th toggle switch's functionality can be customized according to specific user needs and/or preferences, making it a versatile component in user interface design. The toggle switch 212 may be implemented in various forms, including a sliding mechanism, a checkbox, or a button with on/off states, adapting to different user interface designs and device capabilities.

The optional field toggle switch 214 may serve as a complementary control to the main toggle switch 212, allowing users to selectively display or hide optional data entry fields within the user interface 205. This optional field toggle switch 214 may be positioned adjacent to the main toggle switch 212, in examples, for easy access and visual association. The optional field toggle switch 214 may feature a distinct visual design, such as a different color and/or icon, to differentiate it from the main toggle switch 212. Users may interact with the optional field toggle switch 214 by tapping, clicking, or sliding it, depending on the specific implementation and device type. When activated, the optional field toggle switch 214 may cause the user interface 205 to display additional data entry fields that are not required for form completion but may provide supplementary information. The optional field toggle switch 214 may be implemented in various forms, including a sliding mechanism, a checkbox, or a button with on/off states, adapting to different user interface designs and device capabilities. In examples, the system may receive user input data indicating selection of the optional field toggle switch 214 (otherwise described as a second option) associated with optional data entry fields. This selection may prompt a form component 118 (described with respect to FIG. 1) to identify optional data entry fields that are unfilled. The UI element component 116 may then determine another subset of user interface elements corresponding to these optional unfilled fields. The system may subsequently cause this subset of optional field elements to be rendered on a client device via the user interface 205 or 210.

As shown in FIG. 2, when a user selects the toggle switch 212, the user interface 205 may transition to the user interface 210. The user interface 210 may include the data entry fields that are required and incomplete and may exclude (or otherwise may have removed) the optional data entry fields (whether complete or not) and the required data entry fields that have been completed. When this occurs, other (perhaps later) data entry fields such as Data Entry Field 6 216 may be displayed on the screen at the same time as other required and incomplete data entry fields.

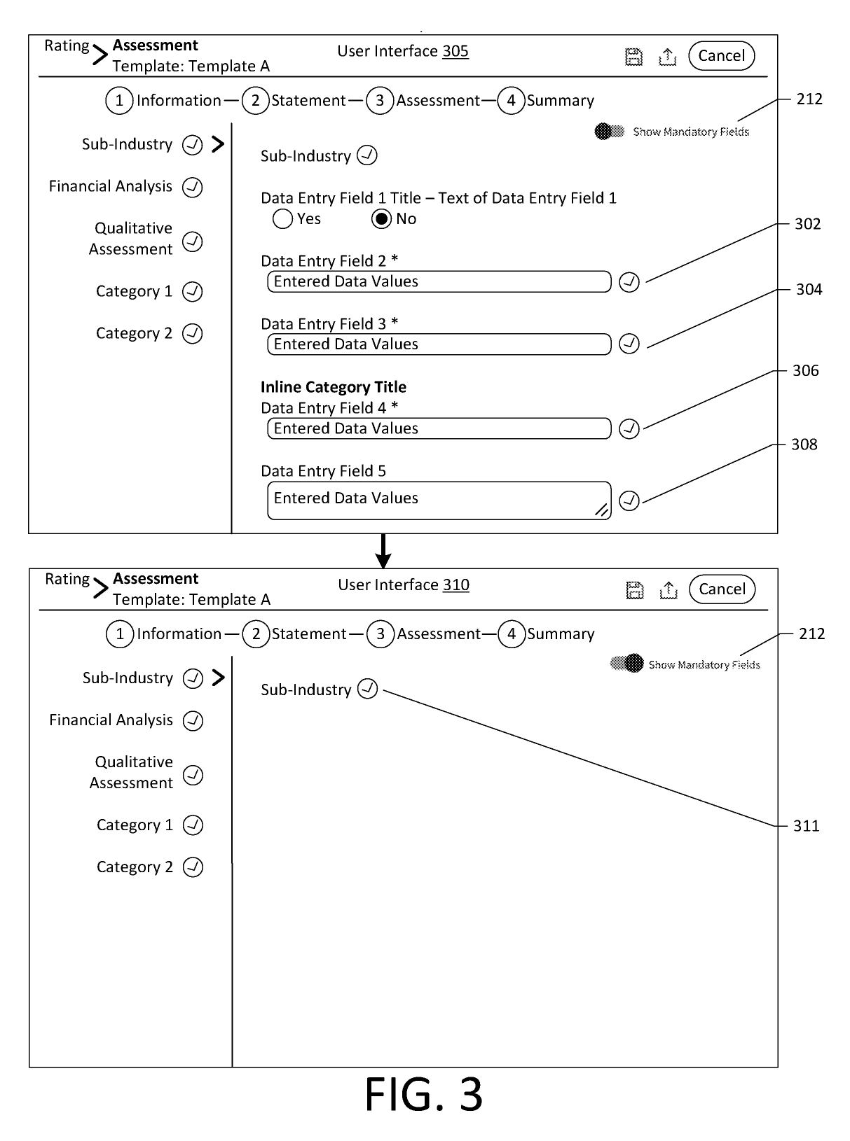

FIG. 3 illustrates example user interfaces showing different states of a form display, according to an embodiment. The user interface 305 may include multiple completed fields, such as a completed field 302, a completed field 304, a completed field 306, and a completed field 308. These completed fields may contain entered data values and may be arranged in a sequential format within the user interface 305.

The user interface 305 may utilize visual cues such as checkmarks, highlighted borders, or color-coded indicators to denote the completion status of each field. A scroll bar or pagination system may be implemented to navigate through extensive forms that extend beyond the visible screen area. The user interface 305 may incorporate interactive elements to enhance user experience and streamline data management. For example, users may be able to edit completed fields by tapping or clicking on them, which may trigger an edit mode or expand the field for modification. The user interface 305 may also feature a search function and/or filtering options to quickly locate specific fields within large forms. Additionally, the toggle switch 212 may be prominently displayed, allowing users to switch between viewing all fields and only incomplete required fields, thereby providing flexibility in how users interact with and manage the form data. As shown in the user interface 305, the toggle switch 212 is not activated such that completed questions are still visible.

The user interface 310 may present a streamlined view of the form shown in the user interface 305, focusing on essential data entry fields. The user interface 310 may utilize a responsive touchscreen display, adapting to various device types and screen sizes. In this view, unfilled and required fields are visible, with other fields being removed or hidden from view. The layout may be organized in a vertical, scrollable format, allowing users to easily navigate through the remaining fields. Visual indicators such as asterisks or highlighted borders may be used to emphasize the required nature of these fields. The toggle switch 212 remains prominently displayed, allowing users to switch back to the full form view if needed. In this example, the toggle switch 212 has been activated such that none of the data entry fields on the form are visible because all of the data entry fields have been completed. When this occurs, a sub-category indicator 311 may indicate that all data entry fields on the form have been completed.

As described with respect to FIG. 1, the UI configurability component 114 may cause the toggle switch 212 to be rendered via the user interface 305 based on detecting a user interface configurability trigger. This trigger may be determined by various factors, such as the number of data entry fields, user preferences stored in a user profile, and/or recommendations from an artificial intelligence model. The system may receive first user input data indicating selection of the toggle switch 212. This selection may trigger the UI element component 116 described with respect to FIG. 1 to adjust the visibility of data entry fields within the user interface 305. When the toggle switch 212 is activated to show only required fields, the system may identify which of the data entry fields are indicated as being unfilled and required. The UI element component 116 may then determine a subset of user interface elements that correspond to these unfilled and required data entry fields. Subsequently, the system may cause this subset of user interface elements to be rendered on a client device via the user interface 310, while removing other user interface elements that are either filled or optional.

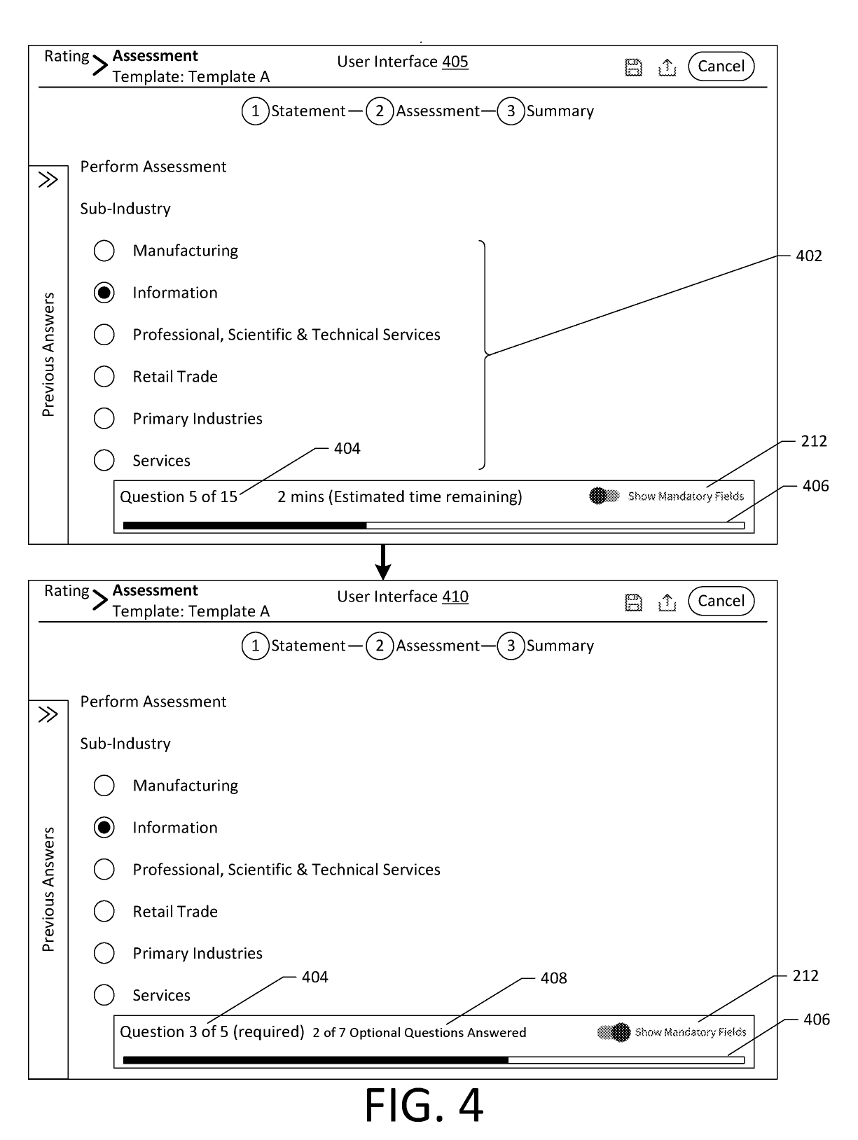

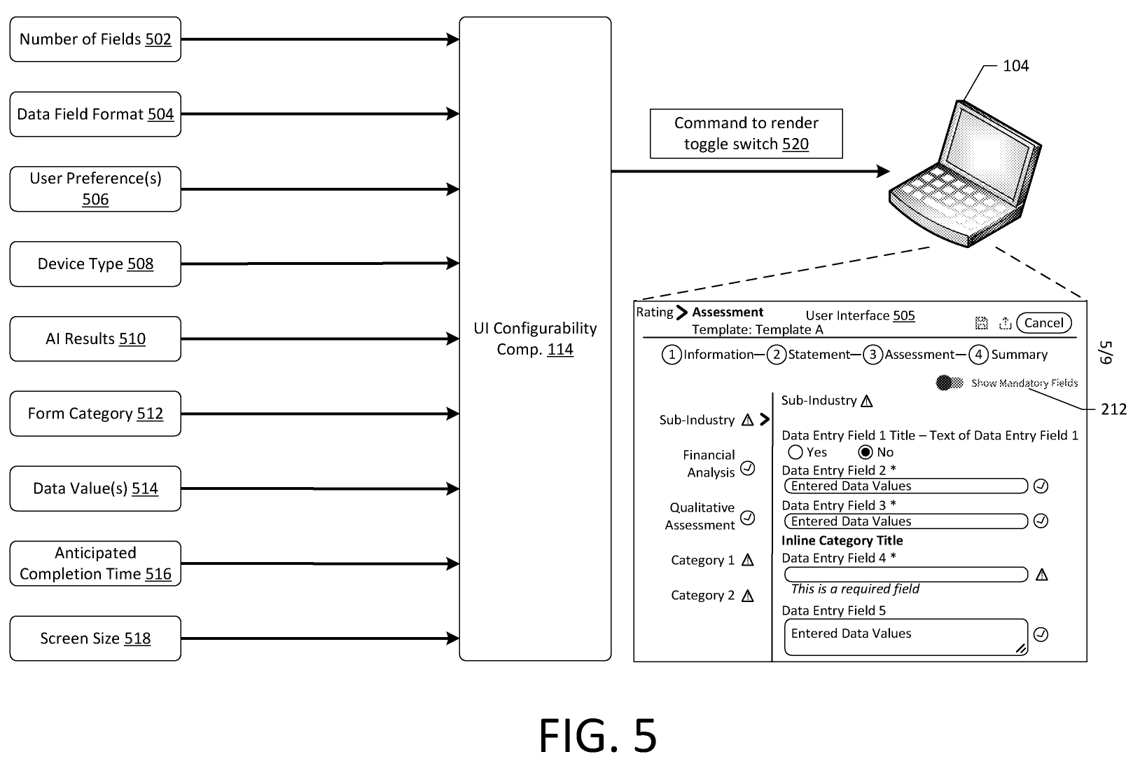

The toggle switch 212 functionality may be particularly useful in scenarios where forms contain a large number of fields, as illustrated in FIG. 4 (described in more detail below). The user interface 405 may display an industry group 402 selection with multiple options. The toggle switch 212 in this interface may allow users to focus on mandatory fields, potentially simplifying the form completion process. Furthermore, as shown in FIG. 5 (again described in more detail below), FIG. 5 illustrates how various input parameters may influence the rendering of the toggle switch 212. The UI configurability component 114 may consider factors such as the number of fields 502, data field format 504, user preference 506, and device type 508, for example, when determining whether to render the toggle switch 212 on the client device. This adaptive approach may enhance the user experience by providing relevant form navigation tools based on the specific context of form completion.

In examples, the user interface 205 or the user interface 310 may include a progress indicator showing overall form completion status. The progress indicator may provide users with a visual representation of their progress through the form. This may help users gauge how much of the form remains to be completed. The user interface 205 or the user interface 310 may also include a progress bar indicating percentage of form completion. The progress bar may fill or advance as users complete more fields, offering a quick and intuitive way to understand form completion progress. Additionally, the user interface 205 or the user interface 310 may feature an optional question counter showing the number of optional fields remaining. This counter may help users prioritize their form-filling efforts by distinguishing between required and optional fields. The UI element component 116 stored in memory of a remote system may be responsible for rendering these various user interface elements on the client device. A form component 118 (described with respect to FIG. 1, above) may work in conjunction with the UI element component 116 to manage the status of data entry fields and update the completion indicators and progress tracking elements accordingly. By incorporating these visual cues and progress tracking features, the user interface may enhance the form completion experience, potentially improving efficiency and reducing user frustration during data entry tasks.

FIG. 4 illustrates example user interfaces 405, 410 for a single-question form display, according to aspects of the present disclosure. FIG. 4 illustrates a user interface 405 that may include various progress tracking features to guide users through form completion. In examples, the user interface 405 may include an industry group 402, which may be an example of a question presented via the user interface 405. The user interface 405 may also include a progress indicator 404, which may provide users with a visual representation of their overall form completion status. In the example of FIG. 4, the progress indicator 404 may indicate that 5 of 15 total questions have been completed.

The user interfaces 405, 410 from FIG. 4 may be associated with individual data entry field display. The system environment may determine that the user interface elements corresponding to data entry fields are to be displayed via the user interface individually such that a single data entry field may be displayed at a given time. This approach may help focus the user's attention on one question at a time, potentially reducing cognitive load and improving data entry accuracy.

The user interface 405 may also include a progress bar 406. The progress bar 406 may fill or advance as users complete more data entry fields, offering a quick and intuitive way to understand form completion progress. In examples, the progress bar 406 may indicate the percentage of form completion. In the example of user interface 405, the toggle switch 212 may be deactivated such that all questions (whether required or not) are included in the counts for the progress bar 406 and/or the progress indicator 404. In examples, user input data may be received selecting the toggle switch 212, which may cause the user interface 405 to transition to the user interface 410.

With respect to the user interface 410, the user interface 410 may include an optional question counter 408 showing the number of optional fields remaining. The optional question counter 408 may help users prioritize their form-filling efforts by distinguishing between required and optional fields. As shown in FIG. 4, the optional question counter 408 may display "2 of 7 Optional Questions Answered". In this example, even though the user had previously completed 5 questions (from the user interface 405), because the toggle switch 212 has been activated and thus required questions are in question, the optional question counter 408 may provide an indication that in addition to the 3 required data entry fields that have been completed, 2 optional data entry fields have been completed. This may ease confusion on the part of the user when they activate and deactivate the toggle switch 212.

In examples, the user interface 405 may display an estimated completion time. As shown in FIG. 4, the user interface 405 may indicate "2 minutes remaining" at the bottom of the screen. This estimated completion time may be calculated based on factors such as the number of remaining fields, the complexity of the questions, and historical data on user completion times. Additionally, in examples, the system environment may render an explanatory user interface element proximate to the toggle switch. This explanatory user interface element may indicate a first number of unfilled data entry fields when the toggle switch is inactive and a second number of the unfilled data entry fields when the toggle switch is active. For example, when the toggle switch is inactive, the explanatory user interface element may display "15 unfilled fields remaining". When the toggle switch is activated to show only required fields, the explanatory user interface element may update to display "5 required fields remaining". By incorporating these visual cues and progress tracking features, the user interface may enhance the form completion experience, potentially improving efficiency and reducing user frustration during data entry tasks. The UI configurability component may adjust the display of these progress tracking elements based on factors such as the device type, user preferences stored in the user profile, and recommendations from the artificial intelligence model.

FIG. 5 illustrates a block diagram of a system showing the inputs and decision-making process of a UI configurability component 114, as described in more detail above with respect to FIG. 1. The UI configurability component 114 may receive various data types that may be utilized to determine whether and/or how to display a toggle switch, such as the toggle switch 212 described above. The data types may include a number of fields 502, which may indicate the quantity of data entry fields in a user interface and/or form. The data types may also include a data field format 504, which may specify the format of the data fields to be displayed. The UI configurability component 114 may also consider a user preference 506 and/or a device type 508 when making rendering decisions.

In examples, the UI configurability component 114 may receive artificial intelligence results 510 from an artificial intelligence model, such as the artificial intelligence model 122 described with respect to FIG. 1. These results may provide insights into user behavior and/or form complexity. A form category 512 may also be considered, which may indicate the type and/or purpose of the form being displayed. Furthermore, the UI configurability component 114 may analyze data values 514 associated with filled data entry fields. An anticipated completion time 516 for the form may be also calculated and considered in the decision-making process. The screen size 518 of a client device may also be taken into account.

To illustrate the above, the UI configurability component 114 may detect a user interface configurability trigger associated with the user interface elements. In examples, this trigger may correspond to the data entry fields being associated with a sequential data field format. For example, the UI configurability component 114 may determine that the data entry fields are associated with the sequential data field format instead of a decision-tree data field format. This determination may influence the decision to render the toggle switch 212. The UI configurability component 114 may also consider the form category 512 when making rendering decisions. In examples, the UI configurability component 114 may determine that the category is associated with the toggle switch 212 and may render the toggle switch 212 based at least in part on this association.

The anticipated completion time 516 may play a role in the rendering decision. For example, the UI configurability component 114 may determine an anticipated amount of time to fill the data entry fields. In examples, if the anticipated amount of time satisfies a threshold amount of time, the UI configurability component 114 may render the toggle switch 212 based at least in part on this determination. The screen size 518 of the client device may be another factor in the rendering decision. The UI configurability component 114 may determine that the screen size 518 satisfies a threshold screen size for rendering the toggle switch 212 and may render the toggle switch 212 based at least in part on this determination.

Additionally, or alternatively, the user interface configurability trigger may correspond to a threshold number of data entry fields. The UI configurability component 114 may determine the number of data entry fields 502 and compare it to the threshold. If the number of data entry fields 502 exceeds the threshold, this may trigger the rendering of the toggle switch 212. In further examples, the UI configurability component 114 may analyze the data values 514 associated with the data entry fields that have been filled. In examples, the UI configurability component 114 may determine that attributes of the data values 514 indicate that the toggle switch 212 is to be rendered and may render the toggle switch 212 based on this determination. These attributes may include, by way of nonlimiting example, whether the data values 514 include numbers, a text narrative, a length of the data values 514, a timing of when the data values 514 were entered, and the like.

Based at least in part on these inputs, the UI configurability component 114 may determine whether to render the toggle switch 212. If the decision is made to render the toggle switch 212, the UI configurability component 114 may send a command 520 to render the toggle switch at instructions, which may cause the actual rendering of the toggle switch 212 on the client device. By considering these various factors, the UI configurability component 114 may make informed decisions about when and how to render the toggle switch 212, potentially enhancing the user experience and improving form completion efficiency.

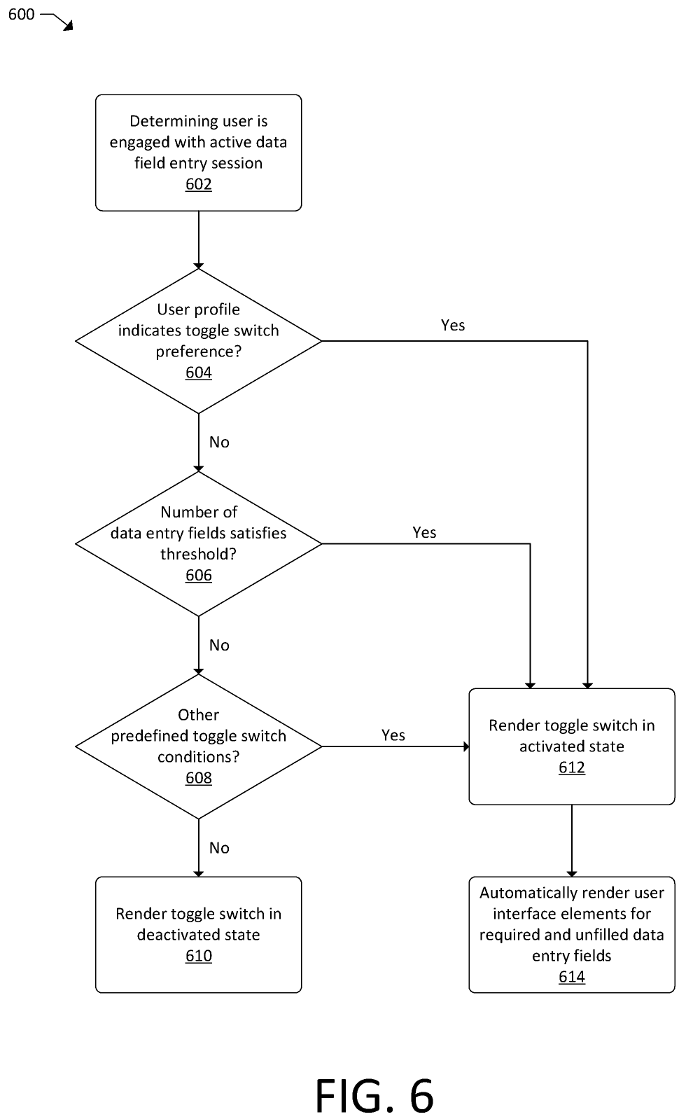

FIGS. 6-9 illustrate processes 600-900 for user interface field configurability enhancements. The processes 600-900 described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes 600-900 are described with reference to the environments, architectures and systems described in the examples herein, such as, for example those described with respect to FIGS. 1-5, although the processes 600-900 may be implemented in a wide variety of other environments, architectures and systems.

FIG. 6 illustrates a flowchart of a process 600 for managing toggle switch activation and user interface element rendering. The order in which the operations or steps are described is not intended to be construed as a limitation, and any number of the described operations may be combined in any order and/or in parallel to implement process 600.

The process 600 may begin at a step 602 with a system determining whether a user is engaged with an active data entry field entry session. For example, the system may monitor user interactions with the user interface to detect ongoing form completion activities. The system may check for recent user input, cursor activity within data entry fields, and/or the presence of partially completed form sections. This determination may serve as a prerequisite for subsequent steps in the process, as it helps establish whether the user interface configurability enhancements are relevant to the current user state. If an active session is detected, the system may proceed to evaluate additional factors for rendering the toggle switch. In cases where no active session is detected, the system may defer further actions related to toggle switch activation until user engagement resumes.

The process 600 may then proceed to a step 604, where the process 600 may include the system checking if the user profile indicates a toggle switch preference. In examples, a UI configurability component may determine that the user profile indicates a preference to view the data entry fields indicated as being unfilled and required. For example, the system may access and analyze user profile data to determine if the user has previously expressed a preference for using the toggle switch functionality. The UI configurability component may examine stored user settings, historical interaction data, and/or explicitly defined preferences within the user profile. If a preference for the toggle switch is detected, this information may be used to influence the decision-making process for rendering the toggle switch in subsequent steps. The system may consider factors such as frequency of past toggle switch usage, default view settings, and/or user-defined rules for form interaction. By evaluating the user profile at this stage, the system may tailor the user interface experience to align with individual user preferences, potentially enhancing usability and user satisfaction.

In examples where the user profile in question does not indicate a toggle switch preference, at the step 606, the process 600 may include the system determining whether the number of data entry fields satisfies a threshold. This determination may involve comparing the total count of data entry fields in the current form or interface to a predefined threshold value. The threshold may be set based on various factors such as device capabilities, user preferences, and/or empirical data on form complexity. In examples, the UI configurability component may dynamically adjust this threshold based on real-time performance metrics and/or user interaction patterns. If the number of data entry fields exceeds the threshold, this may trigger subsequent actions related to rendering the toggle switch. This step may help optimize the user interface for forms with varying levels of complexity, potentially improving the overall user experience for data entry tasks.

In examples where the number of data entry fields does not exceed the threshold, at the step 608, the process 600 may include the system evaluating whether other predefined toggle switch conditions exist. This step may involve analyzing various inputs as illustrated in FIG. 5. For example, a UI configurability component may consider factors such as the data field format, which may indicate whether the form uses a sequential or decision-tree structure. The system may also examine the form category to determine if the type of form being displayed is associated with toggle switch functionality. Additionally, the UI configurability component may analyze the data values of filled fields to assess form complexity. The anticipated completion time may be calculated and compared to a threshold to determine if the toggle switch would be beneficial. The screen size of the client device may also be evaluated to ensure the toggle switch can be effectively displayed. If any of these conditions are met, the system may proceed to render the toggle switch. This comprehensive evaluation allows the system to make context-aware decisions about toggle switch rendering, potentially enhancing user experience across various form types and device configurations.

In examples where no other predefined toggle switch conditions are present, at the step 610, the process 600 may include the system rendering the toggle switch in a deactivated state. For example, the system may generate and display a visual representation of the toggle switch that indicates it is not currently active. The toggle switch may be presented with a specific appearance, such as a grayed-out color or a particular position, to signify its deactivated status. This rendering may occur when the system determines that the conditions for activating the toggle switch have not been met based at least in part on the evaluations performed in the previous steps. Note that unlike FIG. 5, the UI configurability component may be utilized not only to determine whether to display the toggle switch, but also whether to display the toggle switch in a deactivated state. The deactivated toggle switch may still be visible to the user, potentially allowing for future activation if conditions change or if the user manually interacts with it. This step may help maintain consistency in the user interface by always displaying the toggle switch, while clearly indicating its current state and availability for use.

In examples where the user profile indicates a toggle switch preference, and/or when the number of data entry fields satisfies the threshold, and/or when one or more predefined toggle switch conditions are met, the system may proceed to step 612 where the toggle switch may be rendered by the system in an activated state. In this step, the system may generate and display a visual representation of the toggle switch that indicates it is currently active and ready for user interaction. The toggle switch may be presented with a specific appearance, such as a highlighted color or a particular position, to signify its activated status. This rendering may occur when the system determines that the conditions for activating the toggle switch have been met based at least in part on the evaluations performed in the previous steps. The activated toggle switch may allow users to immediately interact with it, potentially enabling them to filter or modify the display of data entry fields. This step may enhance the user interface by providing a clear visual cue that additional functionality is available, which may improve the overall form completion experience.

The process 600 may then move to step 614, where the system may automatically render user interface elements for required and unfilled data entry fields. In examples, the system may analyze the form structure to identify which fields are marked as required and have not yet been completed by the user. A UI element component may then generate and display visual representations of these identified fields within the user interface. This process may include applying specific styling or highlighting to distinguish these fields from optional or completed fields. The system may also reorganize the layout of the form to prioritize the display of these required and unfilled fields, potentially bringing them to the forefront of the user's attention. Additionally, the step may involve updating any progress indicators or completion status elements to reflect the current state of the form after the toggle switch activation.

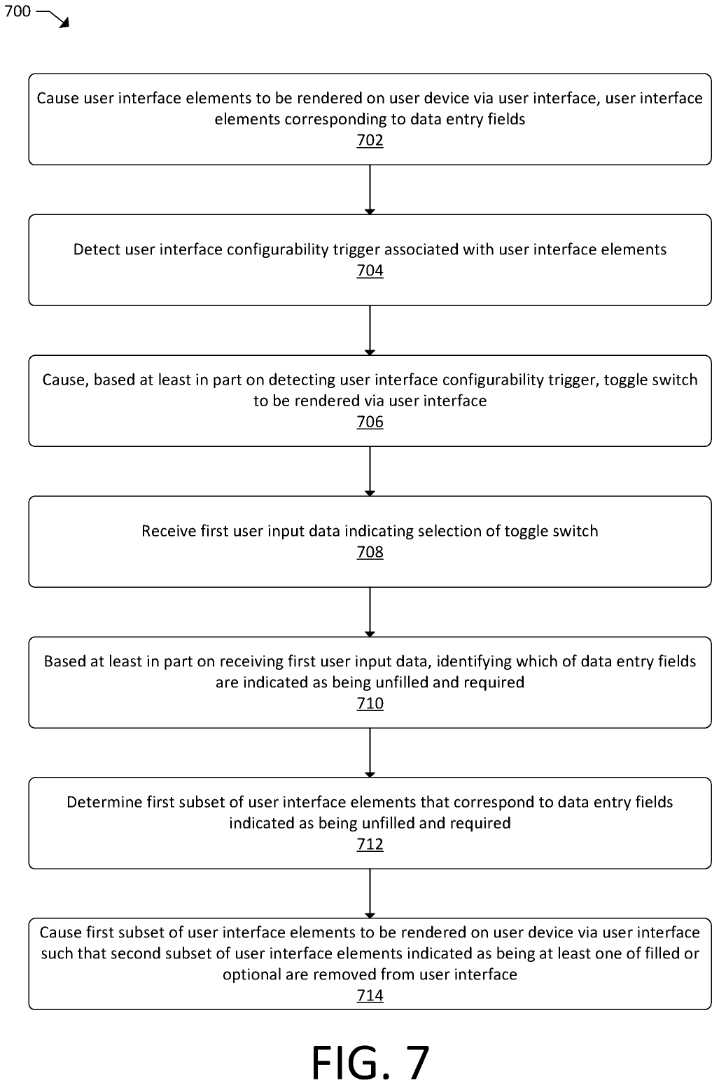

FIG. 7 illustrates a flowchart of a process 700 for managing user interface elements based on data entry field status. The order in which the operations or steps are described is not intended to be construed as a limitation, and any number of the described operations may be combined in any order and/or in parallel to implement process 700.

The process 700 may begin at a step 702, where user interface elements corresponding to data entry fields may be rendered by a system on a client device via a user interface. For example, this rendering process may be initiated when a user accesses a form or application through a client device. The system may generate and display visual representations of various data entry fields, which may include text input boxes, dropdown menus, checkboxes, or other input mechanisms. These user interface elements may be arranged according to a predefined layout or template, taking into account factors such as the form structure, device screen size, and user preferences. The rendering of these elements may also involve applying appropriate styling, such as highlighting required fields or indicating completion status. This step may set the foundation for user interaction with the form, providing the visual and functional components necessary for data input and form completion.

At a step 704, the process 700 may include the system detecting a user interface configurability trigger associated with the user interface elements. As illustrated more completely in FIG. 5, this detection process may utilize multiple input parameters processed by a UI configurability component. The system may consider factors such as the number of fields, data field format, user preference, and/or device type. Additionally, the system may incorporate artificial intelligence results, form category type, data values, anticipated completion time, and/or screen size into the detection of the user interface configurability trigger. The UI configurability component may analyze some or all of these inputs to determine if a trigger condition is met. For example, if the number of fields exceeds a certain threshold, or if the user preference indicates a desire for customizable interfaces, a trigger may be detected.

Following detection of the trigger, at a step 706, the process 700 may include the system causing a toggle switch to be rendered via the user interface. In this step, the system may generate and display a visual representation of the toggle switch within the user interface layout. The toggle switch may be positioned in a prominent location, such as near the top of the form or in a fixed position on the screen, to ensure easy access for users. The rendering process may involve applying appropriate styling to the toggle switch, which may include visual cues to indicate its current state (e.g., activated or deactivated) and its interactivity. The system may also incorporate animations or transitions when rendering the toggle switch to draw user attention to this new interface element. In some implementations, the toggle switch may be accompanied by explanatory text or tooltips to clarify its functionality. The rendered toggle switch may provide users with a mechanism to dynamically adjust the visibility of form fields, potentially simplifying complex interfaces and improving the overall user experience.

The process 700 may then proceed to a step 708, where first user input data indicating selection of the toggle switch may be received by the system. In this step, the system may detect and process user interaction with the rendered toggle switch interface element. The user input may be captured through various input mechanisms, such as touch events on a touchscreen device, mouse clicks, keyboard inputs, or voice commands. The system may register the state change of the toggle switch and prepare to execute the corresponding actions based on this user selection. The received input data may be temporarily stored or immediately processed to inform the next steps in the workflow, such as identifying which data entry fields to display or hide.

At a step 710, based at least in part on receiving the first user input data, the process 700 may include the system identifying which of the data entry fields are indicated as being unfilled and required. This identification process may be performed by analyzing the current state of the form and its constituent fields. The system may utilize a form component to iterate through the data entry fields, checking their completion status and requirement flags. In implementations, this step may involve querying a database or data structure that maintains real-time information about field states. The identification process may also consider any conditional logic that determines field requirements based on user inputs and/or form context. The system may generate a list or data structure containing references to the identified unfilled and required fields, which may be used in subsequent steps to update the user interface.

The process 700 may then move to a step 712, where a first subset of user interface elements that correspond to the data entry fields indicated as being unfilled and required may be determined by the system. In this step, the system may utilize the list or data structure generated in the previous step to identify the specific user interface elements associated with the unfilled and required fields. A UI element component may analyze the form structure and map the identified fields to their corresponding visual representations within the user interface. This determination process may involve filtering out elements that do not meet the criteria of being both unfilled and required. The system may also consider any dynamic dependencies between fields, ensuring that all relevant elements are included in the subset. The resulting first subset of user interface elements may be stored in memory or tagged within the existing interface structure, preparing them for subsequent rendering or manipulation in the following steps of the process.

The process 700 may conclude at a step 714, where the first subset of user interface elements may be rendered by the system on the client device via the user interface such that a second subset of user interface elements indicated as being at least one of filled or optional are removed from the user interface. In this step, the system may dynamically update the user interface to display only the unfilled and required data entry fields identified in previous steps. The rendering process may involve manipulating the Document Object Model (DOM) of the web page in question or adjusting the view hierarchy in a mobile application. The system may apply visual styling to emphasize the remaining fields, such as increased contrast or highlighting. Concurrently, the system may remove or hide the user interface elements corresponding to filled and/or optional fields. This removal process may involve setting display properties to "none," removing nodes from the DOM, and/or updating the visibility attributes of UI components. The system may also implement smooth transitions or animations to enhance the user experience during this interface update. After rendering, the updated user interface may present a streamlined view focused on essential, incomplete fields, potentially improving form completion efficiency.

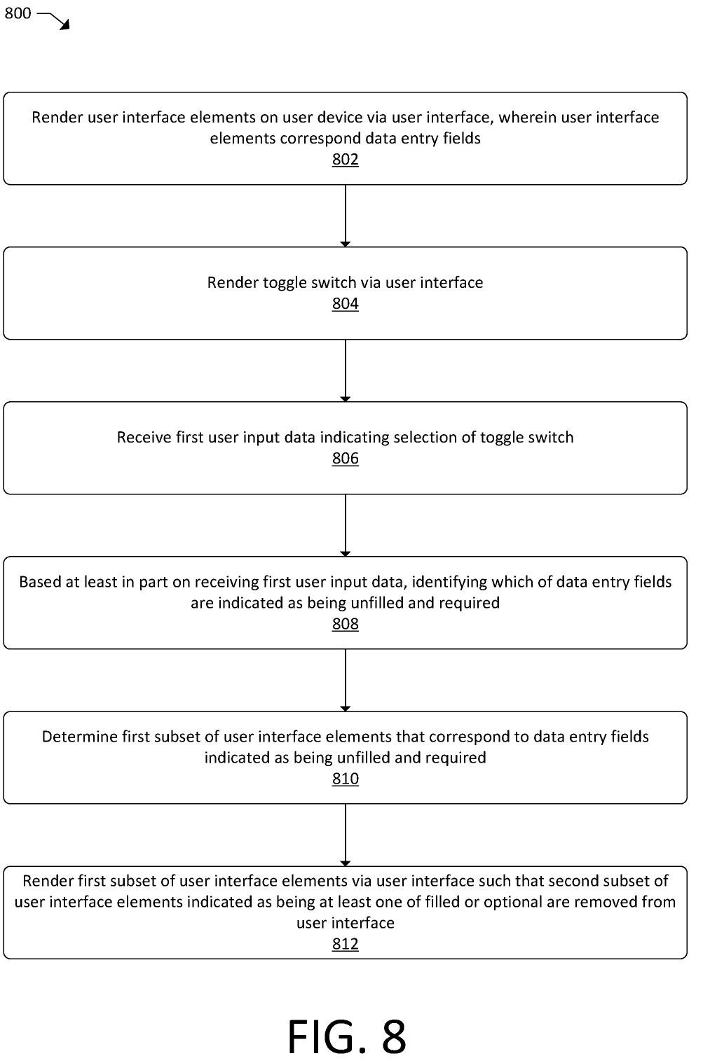

FIG. 8 illustrates a flowchart of a process 800 for managing user interface elements. The order in which the operations or steps are described is not intended to be construed as a limitation, and any number of the described operations may be combined in any order and/or in parallel to implement process 800.

The process 800 may begin at a step 802 with a system rendering user interface elements on a client device via a user interface, where the user interface elements may correspond to data entry fields. For example, this rendering process may be initiated when a user accesses a form or application through a client device. The system may generate and display visual representations of various data entry fields, which may include text input boxes, dropdown menus, checkboxes, or other input mechanisms. These user interface elements may be arranged according to a predefined layout or template, taking into account factors such as the form structure, device screen size, and user preferences. The rendering of these elements may also involve applying appropriate styling, such as highlighting required fields or indicating completion status. This step may set the foundation for user interaction with the form, providing the visual and functional components necessary for data input and form completion.

At a step 804, the process 800 may proceed with the system rendering a toggle switch via the user interface. In this step, the system may generate and display a visual representation of the toggle switch within the user interface layout. The toggle switch may be positioned in a prominent location, such as near the top of the form or in a fixed position on the screen, to ensure easy access for users. The rendering process may involve applying appropriate styling to the toggle switch, which may include visual cues to indicate its current state (e.g., activated or deactivated) and its interactivity. The system may also incorporate animations or transitions when rendering the toggle switch to draw user attention to this new interface element. In some implementations, the toggle switch may be accompanied by explanatory text or tooltips to clarify its functionality. The rendered toggle switch may provide users with a mechanism to dynamically adjust the visibility of form fields, potentially simplifying complex interfaces and improving the overall user experience.

The process 800 may continue at a step 806 with the system receiving first user input data indicating selection of the toggle switch. In this step, the system may detect and process user interaction with the rendered toggle switch interface element. The user input may be captured through various input mechanisms, such as touch events on a touchscreen device, mouse clicks, keyboard inputs, or voice commands. The system may register the state change of the toggle switch and prepare to execute the corresponding actions based on this user selection. The received input data may be temporarily stored or immediately processed to inform the next steps in the workflow, such as identifying which data entry fields to display or hide.

Following the receipt of the first user input data, at a step 808, the process 800 may involve the system identifying which of the data entry fields are indicated as being unfilled and required, based at least in part on receiving the first user input data. This identification process may be performed by analyzing the current state of the form and its constituent fields. The system may utilize a form component to iterate through the data entry fields, checking their completion status and requirement flags. In implementations, this step may involve querying a database or data structure that maintains real-time information about field states. The identification process may also consider any conditional logic that determines field requirements based on user inputs and/or form context. The system may generate a list or data structure containing references to the identified unfilled and required fields, which may be used in subsequent steps to update the user interface.

At a step 810, the process 800 may include the system determining a first subset of user interface elements that correspond to data entry fields indicated as being unfilled and required. In this step, the system may utilize the list or data structure generated in the previous step to identify the specific user interface elements associated with the unfilled and required fields. A UI element component may analyze the form structure and map the identified fields to their corresponding visual representations within the user interface. This determination process may involve filtering out elements that do not meet the criteria of being both unfilled and required. The system may also consider any dynamic dependencies between fields, ensuring that all relevant elements are included in the subset. The resulting first subset of user interface elements may be stored in memory or tagged within the existing interface structure, preparing them for subsequent rendering or manipulation in the following steps of the process.

The process 800 may conclude at a step 812 with the system rendering the first subset of user interface elements via the user interface such that a second subset of user interface elements indicated as being at least one of filled or optional are removed from the user interface. In this step, the system may dynamically update the user interface to display only the unfilled and required data entry fields identified in previous steps. The rendering process may involve manipulating the DOM of the web page in question or adjusting the view hierarchy in a mobile application. The system may apply visual styling to emphasize the remaining fields, such as increased contrast or highlighting. Concurrently, the system may remove or hide the user interface elements corresponding to filled and/or optional fields. This removal process may involve setting display properties to "none," removing nodes from the DOM, and/or updating the visibility attributes of UI components. The system may also implement smooth transitions or animations to enhance the user experience during this interface update. After rendering, the updated user interface may present a streamlined view focused on essential, incomplete fields, potentially improving form completion efficiency.

In examples, the toggle switch may provide a first option associated with required data entry fields, and a second option associated with optional data entry fields. The system may receive second user input data indicating selection of the second option. Based at least in part on receiving the second user input data, the system may identify the optional data entry fields that are unfilled. The system may then cause a third subset of the user interface elements corresponding to the optional data entry fields to be rendered on the client device via the user interface.

In further examples, the system may determine that all of the data entry fields have been filled. The system may remove the user interface elements from the user interface based at least in part on determining that all of the data entry fields have been filled and the toggle switch being activated.

The UI configurability component described herein may also determine a user profile associated with a user that may be utilized with the user interface. In examples, the UI configurability component may determine that the user profile indicates a preference for activating the toggle switch. In these examples, the first user input data may correspond to provision of the preference, and rendering the first subset of the user interface elements may be performed automatically.

The UI configurability component may also determine a number of the data entry fields. In examples, the UI configurability component may determine that the number of the data entry fields satisfies a threshold number of data entry fields. In this example, the first user input data may correspond to viewing the data entry fields, and rendering the first subset of the user interface elements may be performed automatically based at least in part on the number of the data entry fields satisfying the threshold number of data entry fields.

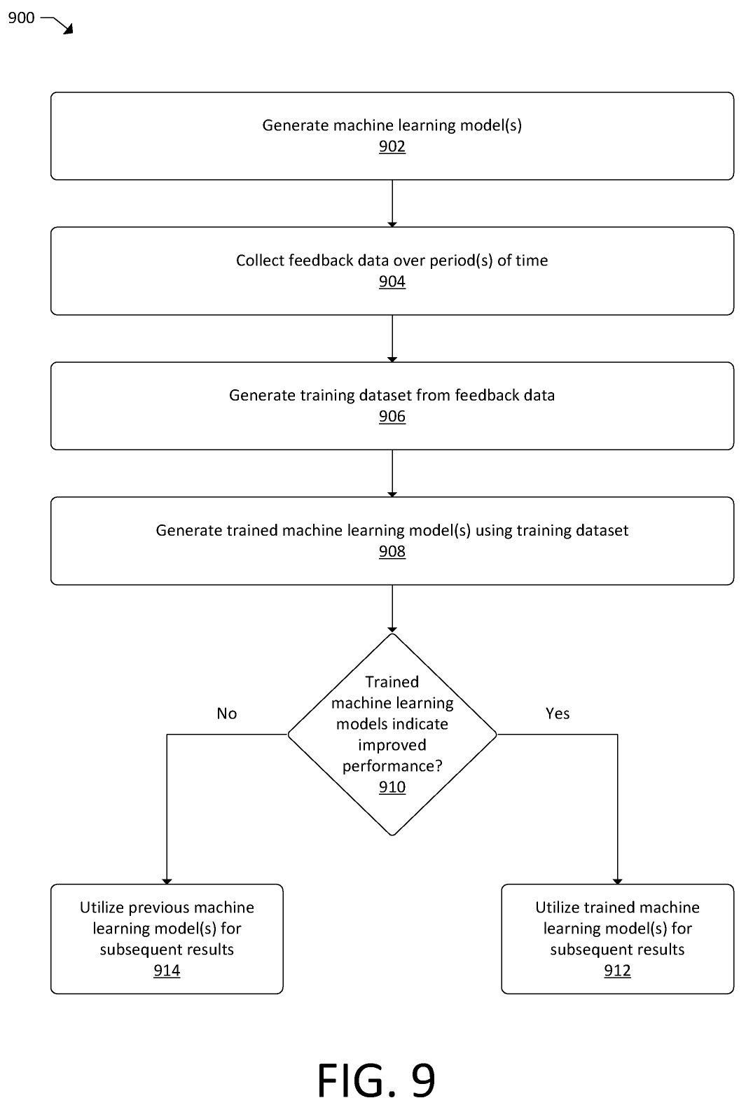

FIG. 9 is a flow diagram of an example process 900 for the generation and training of artificial intelligence models (also referred to herein as machine learning models) to perform one or more of the processes described herein, according to an example described herein. The order in which the operations or steps are described is not intended to be construed as a limitation, and any number of the described operations may be combined in any order and/or in parallel to implement process 900.

At block 902, the process 900 may include generating one or more artificial intelligence models, such as a machine learning model. A number of artificial intelligence techniques may be employed to generate and/or modify the layers and/or models described herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based artificial intelligence.

At block 904, the process 900 may include collecting feedback data over a period of time. The feedback data may include any data associated with determining questions and/or activities to present to a user, any described with respect to FIGS. 1-8, or any other data that may be utilized to perform the operations described herein. This information may include, for example, user input data, user activity data, etc.

At block 906, the process 900 may include generating a training dataset from the feedback data. Generation of the training dataset may include formatting the feedback data into input vectors for the artificial intelligence model to intake, as well as associating the various data with the outcomes of the questions and/or activities described herein.

At block 908, the process 900 may include generating one or more trained artificial intelligence models utilizing the training dataset. Generation of the trained artificial intelligence models may include updating parameters and/or weightings and/or thresholds utilized by the models to determine appropriate questions to present to the user, appropriate activities to recommend, and the like.

At block 910, the process 900 may include determining whether the trained artificial intelligence models indicate improved performance metrics. For example, a testing group may be generated where the outcomes of given questions and/or activities are known but not to the trained artificial intelligence models. The trained artificial intelligence models may generate results, which may be compared to the known results to determine whether the results of the trained artificial intelligence model produce a superior result than the results of the artificial intelligence model prior to training.

In examples where the trained artificial intelligence models indicate improved performance metrics, the process 900 may include, at block 912, utilizing the trained artificial intelligence models for generating subsequent results. For example, the trained artificial intelligence models may be utilized to determine appropriate questions to present to the user, appropriate activities to recommend, appropriate account balances to be maintained, and/or the like. The trained artificial intelligence models may be utilized in any scenario where models are utilized as described herein.

In examples where the trained artificial intelligence models do not indicate improved performance metrics, the process 900 may include, at block 914, utilizing the previous iteration of the artificial intelligence models for generating subsequent results.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A system, comprising:
one or more processors; and
non-transitory computer-readable media storing instructions that, when executed by the one or more processors, cause the system to perform operations comprising:
causing user interface elements to be rendered on a user device via a user interface, the user interface elements corresponding to data entry fields;
detecting a user interface configurability trigger associated with the user interface elements;
causing, based at least in part on detecting the user interface configurability trigger, a toggle switch to be rendered via the user interface;
receiving first user input data indicating selection of the toggle switch;
based at least in part on receiving the first user input data, identifying which of the data entry fields are indicated as being unfilled and required;
determining a first subset of the user interface elements that correspond to the data entry fields indicated as being unfilled and required; and
causing the first subset of the user interface elements to be rendered on the user device via the user interface such that a second subset of the user interface elements indicated as being at least one of filled or optional are removed from the user interface.

2. The system of claim 1, the operations further comprising:
causing the toggle switch to provide (1) a first option associated with required data entry fields, and (2) a second option associated with optional data entry fields;
receiving second user input data indicating selection of the second option;
based at least in part on receiving second user input data, identifying the optional data entry fields that are unfilled; and
causing a third subset of the user interface elements corresponding to the optional data entry fields to be rendered on the user device via the user interface.

3. The system of claim 1, wherein the user interface configurability trigger corresponds to a threshold number of data entry fields, and the operations further comprise:
determining a number of the data entry fields; and
determining that the number of the data entry fields satisfies the threshold number of data entry fields, and wherein detecting the user interface configurability trigger is based at least in part on determining that the number of the data entry fields satisfies the threshold number of data entry fields.

4. The system of claim 1, wherein the user interface configurability trigger corresponds to the data entry fields being associated with a sequential data field format, and the operations further comprise determining that the data entry fields are associated with the sequential data field format instead of a decision-tree data field format, and wherein detecting the user interface configurability trigger is based at least in part on determining that the data entry fields are associated with the sequential data field format instead of the decision-tree data field format.

5. A method, comprising:
rendering user interface elements on a user device via a user interface, wherein the user interface elements correspond to data entry fields;
rendering a toggle switch via the user interface;
receiving first user input data indicating selection of the toggle switch;
based at least in part on receiving the first user input data, identifying which of the data entry fields are indicated as being unfilled and required;
determining a first subset of the user interface elements that correspond to the data entry fields indicated as being unfilled and required; and
rendering the first subset of the user interface elements via the user interface such that a second subset of the user interface elements indicated as being at least one of filled or optional are removed from the user interface.

6. The method of claim 5, further comprising:
rendering, in association with the toggle switch:
a first option associated with required data entry fields; and
a second option associated with optional data entry fields;
based at least in part on receiving second user input data indicating selection of the second option, identifying the optional data entry fields that are unfilled; and
rendering a third subset of the user interface elements corresponding to the optional data entry fields via the user interface.

7. The method of claim 5, further comprising:
determining a number of the data entry fields;
determining that the number of the data entry fields satisfies a threshold number of data entry fields, and wherein rendering the toggle switch is based at least in part on determining that the number of the data entry fields satisfies the threshold number of data entry fields.

8. The method of claim 5, further comprising determining that the data entry fields are associated with a sequential data field format instead of a decision-tree data field format, and wherein rendering the toggle switch is based at least in part on determining that the data entry fields are associated with the sequential data field format instead of the decision-tree data field format.

9. The method of claim 5, further comprising:
determining a user profile of a user interacting with the user interface;
determining that the user profile indicates a preference to view the data entry fields indicated as being unfilled and required, and wherein rendering the toggle switch is based at least in part on determining that the user profile indicates a preference to view the data entry fields indicated as being unfilled and required.

10. The method of claim 5, further comprising:
determining a device type of the user device being utilized to render the user interface elements; and
determining that the device type is a predefined device type associated with rendering of the toggle switch, and wherein rendering the toggle switch is based at least in part on the device type being a predefined device type.

11. The method of claim 5, further comprising:
determining that the user interface elements corresponding to data entry fields are to be displayed via the user interface individually such that a single data entry field is displayed at a given time; and
based at least in part on determining that the user interface elements corresponding to data entry fields are to be displayed via the user interface individually, rendering an explanatory user interface element proximate to the toggle switch, the explanatory user interface element indicating:
a first number of unfilled data entry fields when the toggle switch is inactive; and
a second number of unfilled data entry fields when the toggle switch is active.

12. The method of claim 5, further comprising receiving, from an artificial intelligence model trained to determine a likelihood that the toggle switch will be selected, artificial intelligence results indicating that a user of the user device is likely to select the toggle switch, and wherein rendering the toggle switch is based at least in part on the artificial intelligence results indicating that the user is likely to select the toggle switch.

13. A system comprising:
one or more processors; and
non-transitory computer-readable media storing instructions that, when executed by the one or more processors, cause the system to perform operations comprising:
rendering user interface elements on a user device via a user interface, wherein the user interface elements correspond to data entry fields;
rendering a toggle switch via the user interface;
receiving first user input data indicating selection of the toggle switch;
based at least in part on receiving the first user input data, identifying which of the data entry fields are indicated as being unfilled and required;
determining a first subset of the user interface elements that correspond to the data entry fields indicated as being unfilled and required; and
rendering the first subset of the user interface elements via the user interface such that a second subset of the user interface elements indicated as being at least one of filled or optional are removed from the user interface.

14. The system of claim 13, the operations further comprising:
determining a category of the data entry fields; and
determining that the category is associated with the toggle switch, and wherein rendering the toggle switch is based at least in part on the category being associated with the toggle switch.

15. The system of claim 13, the operations further comprising:
determining data values associated with the data entry fields that have been filled; and
determining that attributes of the data values indicate that the toggle switch is to be rendered, and wherein rendering the toggle switch is based at least in part on determining that the attributes of the data values indicate that the toggle switch is to be rendered.

16. The system of claim 13, the operations further comprising:
determining an anticipated amount of time to fill the data entry fields; and
determining that the anticipated amount of time satisfies a threshold amount of time, and wherein rendering the toggle switch is based at least in part on determining that the anticipated amount of time satisfies the threshold amount of time.

17. The system of claim 13, the operations further comprising:
determining a screen size of the user device; and
determining that the screen size satisfies a threshold screen size for rendering the toggle switch, and wherein rendering the toggle switch is based at least in part on determining that the screen size satisfies the threshold screen size for rendering the toggle switch.

18. The system of claim 13, the operations further comprising:
determining that all of the data entry fields have been filled;
removing the user interface elements from the user interface based at least in part on:
determining that all of the data entry fields have been filled; and
the toggle switch being activated.

19. The system of claim 13, the operations further comprising:
determining a user profile associated with a user that is utilized the user interface;
determining that the user profile indicates a preference for activating the toggle switch, and wherein:
the first user input data corresponds to provision of the preference; and
rendering the first subset of the user interface elements is performed automatically.

20. The system of claim 13, the operations further comprising:
determining a number of the data entry fields;
determining that the number of the data entry fields satisfies a threshold number of data entry fields; and wherein:
the first user input data corresponds to viewing the data entry fields; and
rendering the first subset of the user interface elements is performed automatically based at least in part on the number of the data entry fields satisfying the threshold number of data entry fields.
